(19) United States
(12) Patent Application Publication
(10) Pub. No.: US 2006/0046784 A1
(43) Pub. Date: Mar. 2, 2006

(54) Multiple antenna control mechanism for wireless analog communications

(76) Inventors: Tzu-Hung Chen, Hsin-Chu (TW); Cheng-Hung Lu, Hsin-Chu (TW); Jui-Hung Wei, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/929,392

(22) Filed: Aug. 31, 2004

(51) Int. Cl. H04B 7/14

(52) U.S. Cl. 455/562.1

(57) ABSTRACT

A multiple antenna control mechanism for wireless analog communications is disclosed. The control mechanism includes an antenna switch unit, a receiver unit, and a control unit. The antenna switch unit has multiple sets of reception antennas and associated low-noise amplifiers, and a single-pole-multiple-throw RF switch. It receives a wireless by transmitted RF signal that is carrying analog signals. The RF signal is amplified (and down-converted to an intermediate frequency), filtered, and demodulated by the receiver unit. The resulting RF/IF signal is then fed to the control unit for comparison, analysis and identification. When the reception signal quality is poor, the control unit signals the antenna switch unit to change to another reception antenna for maintaining good reception conditions.

### BACKGROUND OF THE INVENTION

1. Field of Invention

The invention relates to a multiple antenna control mechanism and, in particular, to a multiple antenna switching control mechanism for analog receiver in wireless communications.

2. Related Art

Although digital modulation techniques have been widely used in modem wireless communication systems, today wireless products using analog modulation are still quite popular because of its simplicity and low cost.

There are three commonly used analog modulation types for transmitting analog information by the radio frequency (RF) signal: amplitude modulation (AM), frequency modulation (FM), and phase modulation (PM). Since the analog signal has the characteristic of continuous variation in amplitude, frequency or phase, unlike the simplicity of the digital signal that has only two discrete “0” and “1” states, the analog signal is much more difficult than the digital signal to be analyzed for generating the control signal to optimize the signal reception. Therefore, most communication protocols commonly adopted by the wireless digital communications are not applicable to analog communications.

For indoor applications, the most common problem in wireless analog communications is the multipath fading due to multiple reflections by nearby obstacles. This results in poor signal reception and inconvenient operation of the wireless device for the users. The situation is even worse when the radiation power of the wireless device is restricted to a rather low level like many indoor wireless analog applications. Therefore, how to solve the foregoing problem is an important subject to study.

### SUMMARY OF THE INVENTION

In view of the foregoing problem, the invention provides a multiple antenna control mechanism for wireless analog communications. An objective of the multiple antenna control mechanism is that when the reception quality of the received analog modulated signal is poor, it can automatically switch the reception antenna to the best suitable one. Therefore, the signal reception is always maintained at the optimized condition.

The disclosed multiple antenna control mechanism for wireless analog communications includes an antenna switch unit, a receiver unit, and a control unit. The antenna switch unit has multiple sets of reception antennas and associated low-noise amplifiers, and a single-pole-multiple-throw RF switch. It receives a wirelessly transmitted RF signal that is carrying analog modulated signals. The RF signal is amplified (and down-converted to an intermediate frequency (IF) in some cases), filtered, and demodulated to recover the analog signals by the receiver unit that includes RF unit, filter and demodulator. The recovered analog signal is then fed into the control unit for analysis and identification. The control unit includes an extraction unit and an identification unit. The identification unit may be a set of logic gates with appropriate selection and combination of different types or a single micro controller. The extraction unit extracts certain portion of waveform that is periodic and fixed-amplitude from the recovered analog signal. The identification unit then compares the extracted waveform with a pre-defined standard waveform and analyzes its distortion. In addition, a received signal strength indication (RSSI) signal from the receiver unit may also be used as a further reference in the analysis and identification process in order to determine the quality of the reception signal. If the reception signal quality is poor, the identification unit signals the antenna switch unit to change to another reception antenna for maintaining good reception conditions.

### BRIEF DESCRIPTION OF THE DRAWINGS

The invention will become more fully understood from the detailed description given hereinbelow illustration only, and thus are not limitative of the present invention, and wherein:

FIG. 1 is a functional block diagram of the disclosed multiple antenna control mechanism for wireless analog communications;

FIG. 2 is a schematic view of the antenna switch unit in FIG. 1;

FIG. 3 is a schematic view of the receiver unit in FIG. 1;

FIG. 4 is a schematic view of the control unit in FIG. 1; and

FIG. 5 is a schematic view of an embodiment of the invention.

### DETAILED DESCRIPTION OF THE INVENTION

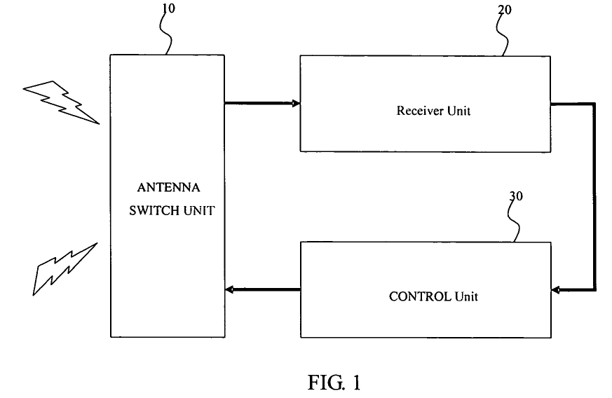

With reference to FIG. 1, the disclosed multiple antenna control mechanism for wireless analog communications includes an antenna switch unit 10, a receiver unit 20, and a control unit 30. The antenna switch unit 10 has a single-pole-multiple-throw radio frequency (RF) switch and multiple sets of reception antennas and associated low-noise amplifiers. The antenna switch unit 10 receives a wirelessly transmitted RF signal that is carrying an analog modulated signal. The analog signal can be a video signal or an audio signal. The receiver unit 20 is connected to the antenna switch unit 10 and is used to amplify (and also to down-convert the frequency in many cases), filter, and demodulate the RF signal to restore the analog signal. The analog signal is then fed into the control unit 30 for analysis and identification. Certain portion of periodic and fixed-amplitude waveform is extracted from the analog signal to be compared with a pre-defined standard waveform. A received signal strength indication (RSSI) from the receiver unit 20 is also used as a reference for the analysis and identification. If the distortion of the waveform and the RSSI level or variation exceed a predetermined combination of limits, a switch control signal is sent to the antenna switch unit 10 to change the reception antenna.

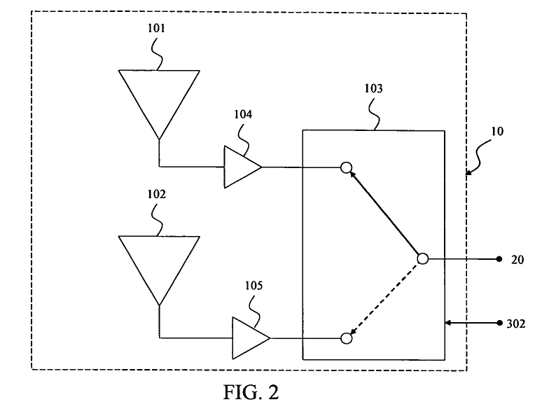

In the following, we use FIG. 2 to explain the antenna switch unit of the invention. The antenna switch unit includes a first reception antenna 101, a second reception antenna 102, a single-pole-multiple-throw RF switch 103, a first low-noise amplifier 104, and a second low-noise amplifier 105. The first reception antenna 101 and the second reception antenna 102 are installed at different spatial locations (and with different polarizations) to receive RF signal coming from different directions (and with different polarizations). The single-pole-multiple-throw RF switch 103 is an RF signal selector. It receives control commands from the control unit 30 to switch the connection to the specified reception antenna in order to maintain good reception signal quality. On the other hand, the first low-noise amplifier 104 and the second low-noise amplifier 105 are optional devices for amplifying the RF signal strength and increasing the signal-to-noise (S/N) ratio of the system.

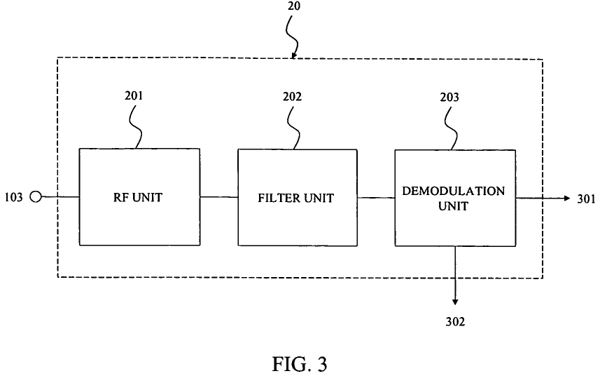

We then use FIG. 3 to explain the receiver unit 20 of the invention. The receiver unit 20 contains an RF unit 201, a filter unit 202, and a demodulation unit 203. The RF unit 201 is connected to the single-pole-multiple-throw RF switch 103. The RF unit 201 can be an RF front end for amplifying the received RF signal. According to the system requirement, the amplified RF signal is sent to the filter unit 202 directly or after its frequency being down-converted to an intermediate frequency (IF). The filter unit 202 can be a band-pass (BP) or low-pass (LP) filter with the appropriate bandwidth to eliminate undesired signals from the RF or IF signal for improving S/N ratio. Finally, the demodulation unit 203 demodulates the RF or IF signal and restores the analog signal.

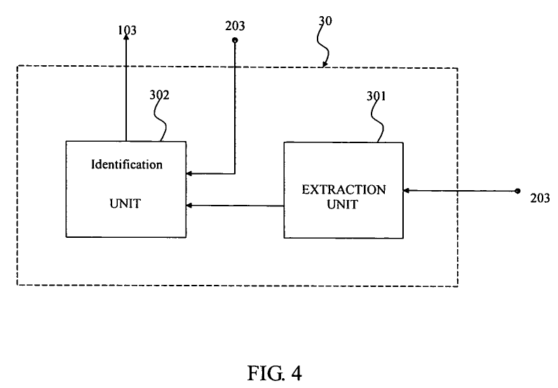

We use FIG. 4 to explain the control unit 30 of the invention. The control unit 30 contains an extraction unit 301 and an identification unit 302. The extraction unit 301 can be a waveform clipper, a band-pass (BP) Filter, or a combination of both, etc. The identification unit 302 can be a logic gate group with appropriate selection and combination of various types or a single micro controller. The extraction unit 301 is connected to the demodulation unit 203 for extracting certain portion of periodic and fixed-amplitude waveform from the demodulated and restored analog signal. The periodic and fixed-amplitude waveform can be sine- or square-wave signals. Such signals include the synchronization signal of a TV signal or the pilot tone or identification signal of an FM stereo audio signal. The periodic and fixed-amplitude signals are then sent to the identification unit 302 to analyze their distortion in terms of the amplitude, phase, and pulse width, etc. In addition, the identification unit 302 also receives the receive signal strength indication (RSSI) generated from the demodulation unit 203 as a reference in determining whether the reception signal quality is not good enough. If the reception signal quality is not good enough, a switch control signal is sent to the single-pole-multiple-throw RF switch 103 to switch the signal path to another antenna.

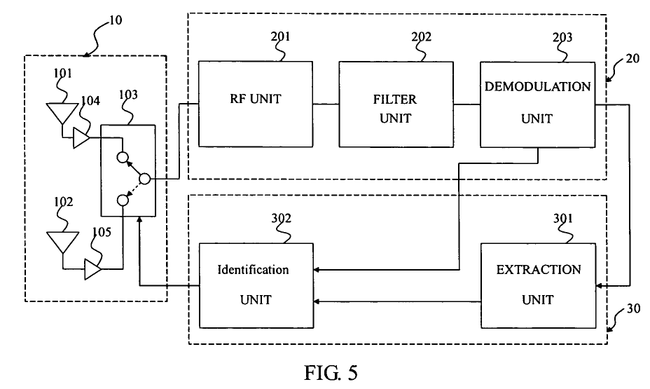

Finally, we use an embodiment, shown in FIG. 5, to demonstrate how the invention works. To begin with, the RF signal carrying an analog signal is received by the first reception antenna 101 in the antenna switch unit 10. After going through the first low-noise amplifier 104 and the single-pole-multiple-throw RF switch 103, the signal is sent to the RF unit 201, the filter unit 202, and the demodulation unit 203 of the receiver unit 20. After the demodulation, an analog signal is restored and sent to the extraction unit 301 of the control unit 30 for extracting a periodic and fixed-amplitude waveform signal. The periodic and fixed-amplitude signal is then sent to the identification unit 302 for comparison with a pre-defined standard waveform. In the meantime, the identification unit 302 also receives an RSSI signal coming from the demodulation unit 203 to analyze its level and variation pattern. Based on the comparison analysis results, the identification unit 302 then determines whether the signal reception quality is not good enough. If the signal reception condition is poor, the identification unit 302 records a set of signal reception status parameters and sends out a switch control signal to the single-pole-multiple-throw RF switch 103. Once receiving the switch control signal, the single-pole-multiple-throw RF switch 103 switches the connection of the output port from the first reception antenna 101 to the second antenna 102. If the signal reception condition of the second reception antenna 102 becomes worse, the identification unit 302 will send another switch control signal to switch back the connection to the first reception antenna 101. The situation that the signal reception conditions are poor for both the first reception antenna 101 and the second reception antenna 102 can only happen under very rare reception environment. In such circumstances, a third reception antenna set or even more can be added to the system to make the probability that all antennas have poor signal reception qualities diminishing.

In conclusion, the multiple antenna control mechanism for wireless analog communications has the capability of automatically switching its reception antenna to the one having the best reception condition. Therefore, it can overcome the problem of poor signal reception conditions caused by the multipath fading due to signal reflections from obstacles or an indoor environment.

Certain variations would be apparent to those skilled in the art, which variations are considered within the spirit and scope of the claimed invention.

What is claimed is:

1. A multiple antenna control mechanism for wireless analog communications, comprising:
an antenna switch unit, which is installed with a plurality of reception antennas at different spacial locations (and with different polarizations) for receiving a wirelessly transmitted radio frequency (RF) signal carrying an analog signal;
a receiver unit connected to the antenna switch unit, which amplifies (and also down-converts the frequency if the system requires), filters, and demodulates the RF signal for restoring an analog signal that is then sent to an output terminal, and generates a received signal strength indication (RSSI) and sends it to another output terminal; and
a control unit connected to the receiver unit, which receives the demodulated analog signal and extracts from the demodulated analog signal at least one periodic and fixed-amplitude waveform signal for the comparison analysis of amplitude, phase and pulse width with a pre-defined standard waveform, receives the RSSI output from the receiver unit as a control analysis reference, and sends out a switch control signal for the antenna switch unit to switch its reception antenna when the distortion of the analog signal and the RSSI level or variation exceed a predetermined combination of limits.

2. The multiple antenna control mechanism for wireless analog communications of claim 1, wherein the antenna switch unit further contains a single-pole-multiple-throw RF switch connected to the plurality of reception antennas for switching to the reception antenna designated by the switch control signal.

3. The multiple antenna control mechanism for wireless analog communications of claim 1, wherein the antenna switch unit comprises a plurality of low-noise amplifiers connected between the reception antennas and the RF switch, if the system requires, to increase the signal-to-noise (S/N) ratio of the system.

4. The multiple antenna control mechanism for wireless analog communications of claim 1, wherein the receiver unit further comprises:
an RF unit connected to the antenna switch unit, which amplifies the RF signal carrying the analog signal and down-converts the frequency of the amplified RF signal, if the system requires, to an intermediate frequency (IF) signal, and outputs the RF or IF signal to the filter unit;
a filter unit connected to the RF unit, which allows the desired RF/IF signal to pass through while removes other undesired signals and noises; and
a demodulation unit connected to the filter unit, which demodulates the RF/IF signal to restore the analog signal and generates a received signal strength indication (RSSI) signal and send it to the output terminal.

5. The multiple antenna control mechanism for wireless analog communications of claim 1, wherein the control unit further comprises:
an extraction unit connected to the demodulation unit, which extracts at least one periodic and fixed-amplitude waveform signal from the demodulated and restored analog signal; and
an identification unit connected to the extraction unit, which compares the amplitude, phase, and waveform of the periodic and fixed-amplitude signal with a pre-defined standard waveform and analyses their distortions, simultaneously receives the RSSI signal pattern from the demodulation unit as a reference for control analysis and comparisons, and sends out the switch control signal when the distortion and the RSSI level or variation exceed a predetermined combination of limits.

6. The multiple antenna control mechanism for wireless analog communications of claim 5, wherein the identification unit analyses extraordinary conditions when the signal reception qualities of all antennas are poor and resumes the optimized signal reception conditions within the shortest possible time.

7. The multiple antenna control mechanism for wireless analog communications of claim 5, wherein the extraction unit is comprised of a waveform clipper.

8. The multiple antenna control mechanism for wireless analog communications of claim 5, wherein the extraction unit is comprised of a band-pass (BP) filter.

9. The multiple antenna control mechanism for wireless analog communications of claim 5, wherein the extraction unit is comprised of a combination of waveform clippers and band-pass (BP) filters.

10. The multiple antenna control mechanism for wireless analog communications of claim 5, wherein the extraction unit is comprised of a time gating circuitry.

11. The multiple antenna control mechanism for wireless analog communications of claim 5, wherein the identification unit is comprised of a group of logic gates with the appropriate selection and combination of various types of logic gate.

12. The multiple antenna control mechanism for wireless analog communications of claim 5, wherein the control unit is comprised of a single micro controller.

13. The multiple antenna control mechanism for wireless analog communications of claim 1, wherein the periodic and fixed-amplitude signal is a synchronization signal in the analog signal.

14. The multiple antenna control mechanism for wireless communications of claim 1, wherein the periodic and fixed-amplitude signal is a pilot tone in the analog signal.

15. The multiple antenna control mechanism for wireless communications of claim 1, wherein the periodic and fixed-amplitude signal is an identification signal in the analog signal.
